(19) United States
(12) Patent Application Publication
(10) Pub. No.: US 2016/0039607 A1
(43) Pub. Date: Feb. 11, 2016

(54) Liner Unit for Chute Wall

(71) Applicant: TEGA INDUSTRIES LIMITED, Kolkata, West Bengal (IN)

(72) Inventors: Madan Mohan Mohanka, Kolkata (IN); Kaushal Kishor, Kolkata (IN)

(73) Assignee: TEGA INDUSTRIES LIMITED, Kolkata, West Bengal (IN)

(21) Appl. No.: 14/781,737

(22) PCT Filed: Jul. 22, 2013
(86) PCT No.: PCT/IN2013/000455

§ 371 Date: Oct. 1, 2015

(30) Foreign Application Priority Data
Apr. 3, 2013 (IN) 374/KOL/2013

(51) Int. Cl. B65G 11/16

(52) U.S. Cl. CPC B65G 11/166

(57) ABSTRACT

A liner unit (1) adapted to be detachably attached on a chute wall (12) comprises a liner base enclosed within an integrally formed frame (2) and having a front (10) and a back face (11), said liner unit (1) is adapted to be affixed with the said chute wall (12) through bolt holes (5) by means of fastening means (8), said liner base being provided with pockets on the surface thereof providing cushioning effect in the event of the liner base being impacted with a load during operation.

### FIELD OF THE INVENTION

The present invention in general relates to chute liners for bulk, rocky, chunky and abrasive material handling, and in particular to liners for chute wall which provide damping action against the high impact forces that result due to falling of such material on the chute walls. The damping action is achieved by the presence of pockets in the liner unit. The liners form an array to cover the surface of the chute wall or any surface subjected to wear.

### BACKGROUND AND PRIOR ART

A material handling system most commonly deploys a plurality of conveyor belts for carrying material over distances and chutes for depositing materials on conveyor belts which is to be carried by these belts.

When material has to be transferred between conveyors at different heights or between conveyors moving in different directions, chutes are used. Chutes are flat plates, arranged at different angles to transfer or guide materials for proper discharge on the following conveyor belt. At the point of material loading, the impact is high on the conveyor, hence impact idlers are provided in this zone to minimize the effect of impact.

Mainly two types of wear can be observed in material handling equipments.

Impact wear: As the particles are not spherical, they have protruding edges which may gouge the liner during impact. This is termed as impact wear.

Abrasion wear: Sliding abrasion is a function of pressure, friction coefficient and sliding velocity. Abrasion wear is high in soft materials.

Wear in Chutes: Chute plates, if left unprotected, wear out with time due to continuous flow of material on them. This wear may finally tear the plate, forming holes in chute faces, leading to leakage and wastage of material. In such condition, entire chutes have to be replaced which halts the production for a long time.

To avoid this, liners are used. Liners are small rectangular blocks, used as sacrificing cover for chute plates. These are mechanically fastened to an inner surface of the chute body.

Following benefits are obtained from chute liner:

1) Facilitates easy and fast repair and replacement of sliding surface

2) Serves as means of correcting the performance of an inadequate chute

3) Avoid abrasion wear of chute

4) Reduces impact wear, noise, dust and material degradation

5) Promotes smooth flow

6) Avoid build-up of material

7) Prevents chemical reaction or corrosion of both the chute surface and product

An ideal chute liner should resist impact and abrasion wear, degradation and fines generation.

Conventionally, rubber liners have been used in chutes of bulk material handling systems which handle rocky and granular heavy material, as in the mining and steel industries.

Rubber liners are generally a good solution for such applications, but suffer from some drawbacks. When rubber liners are installed in a high impact zone of a chute i.e. the area where moving materials have the initial impact on the chute wall, many times crack formation occurs on the rubber surface. This is a result of high impact wear. So there has been a long felt need to develop lining system for chute walls, which can withstand high impact load.

The bubble liners for chute lining according to the present invention meet the aforesaid long felt need and other needs associated therewith.

### OBJECTS OF THE INVENTION

The primary object of the invention is to overcome the drawbacks of the prior art.

Another object of the invention is to provide a bubble liner that reduces impact wear.

Yet another object of the invention is to provide a bubble liner that is suitable for installation in high impact zones.

A further object of the invention is to provide a bubble liner that reduces noise.

Another object of the invention is to achieve reduced material weight and consequently reduced cost of the equipment.

Another object of the invention is to eliminate frequent chute liner replacements.

A further object of the invention is to achieve reduction in stoppage of operation of the material handling system.

### SUMMARY OF THE INVENTION

Accordingly the present invention provides a liner unit adapted to be detachably attached on a chute wall comprises a liner base enclosed within an integrally formed frame and having a front and a back face, said liner unit is adapted to be affixed with the said chute wall through bolt holes by means of fastening means, said liner base being provided with pockets on the surface thereof providing cushioning effect in the event of the liner base being impacted with a load during operation.

Preferably, the surface of said liner base is provided with plurality of spaced apart, integrally formed and longitudinally outwardly protruding protrusions.

Preferably, the plurality of protrusions and pockets are of different shapes and sizes.

The liner unit is provided with a plurality of bolt holes for fastening purposes.

The said bolt holes are provided at the corners of the frame.

Said bolt holes are provided on integrally formed cylindrical portions surrounding the bolt holes.

Preferably a plurality of slots is provided on said frame.

Preferably, said bolt holes on said cylindrical portions are located of the surface of the said liner base.

The frame has an integrally formed cross beam.

The invention also provides an array of liner units adapted to be affixed on chute wall, formed by coplanar connection of a plurality of said liner units as claimed in any previous claim.

### BRIEF DESCRIPTION OF THE ACCOMPANYING DRAWINGS

The nature and scope of the present invention will be better understood from the accompanying drawings, which are by way of illustration of a preferred embodiment and not by way of any sort of limitation. In the accompanying drawings:

FIG. 1 shows a back view of the liner unit of the present invention.

FIG. 2 is a front view of the liner unit of the present invention.

FIG. 3 gives the side view of the liner unit as sown in FIG. 1.

FIGS. 4a, 5a, 6a, 7 and 8 are isometric views of different embodiments of the liner unit according to the invention.

FIGS. 4b, 5b, 6b, 7 and 8 show details of pockets and protrusion (bubble) formations.

FIG. 9 is the isometric view of an array of the liner units fixed on the chute wall.

FIG. 10 is a cross sectional view of the attachment of the liner units with the chute wall.

### DETAILED DESCRIPTION OF THE INVENTION

The bubble liner unit (1) of the invention is now described with the help of the accompanying drawings.

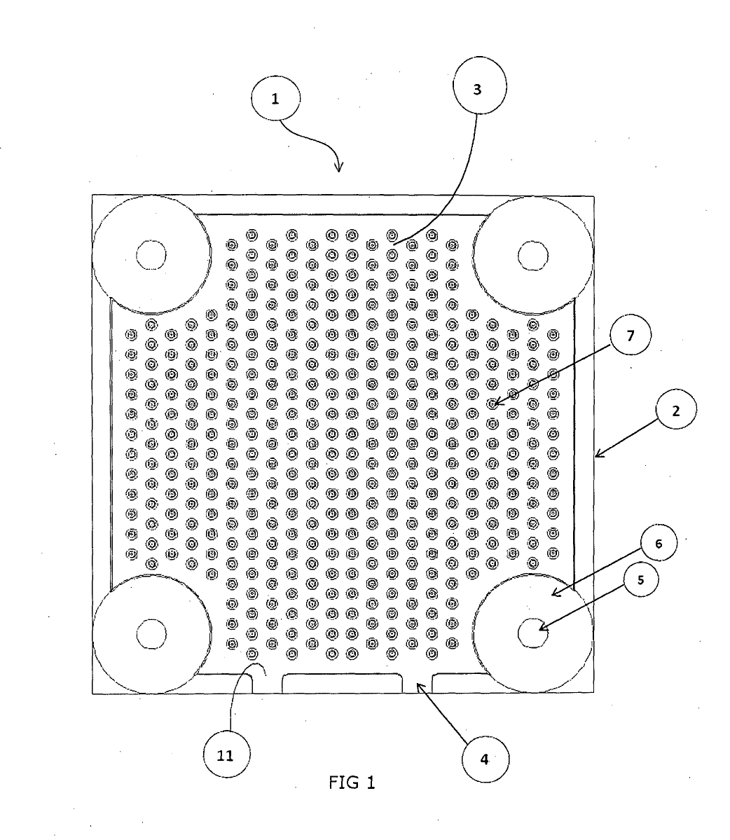

FIG. 1 shows a back view of the bubble liner unit (1). The bubble liner unit (1) consists of a liner base made of non-linear material and is mounted on a substantially rectangular frame (2). The frame is made of the same material as that of the base i.e. non-linear material.

Nonlinearity of the material is used as the liner and the frame have to endure inelastic behavior of a component i.e. they need to exhibit a non-linear stress-strain relationship. A non limiting example of the preferred non-linear material is synthetic rubber.

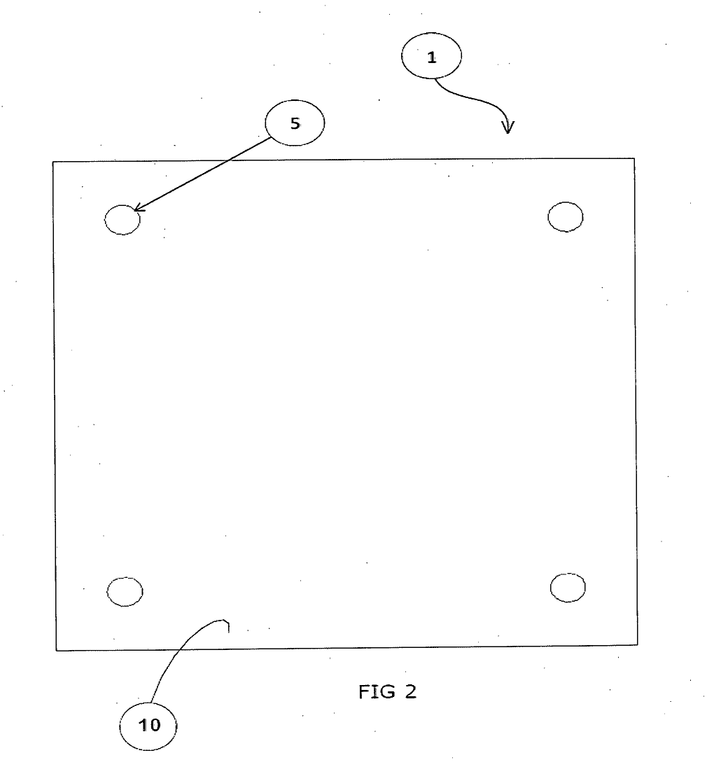

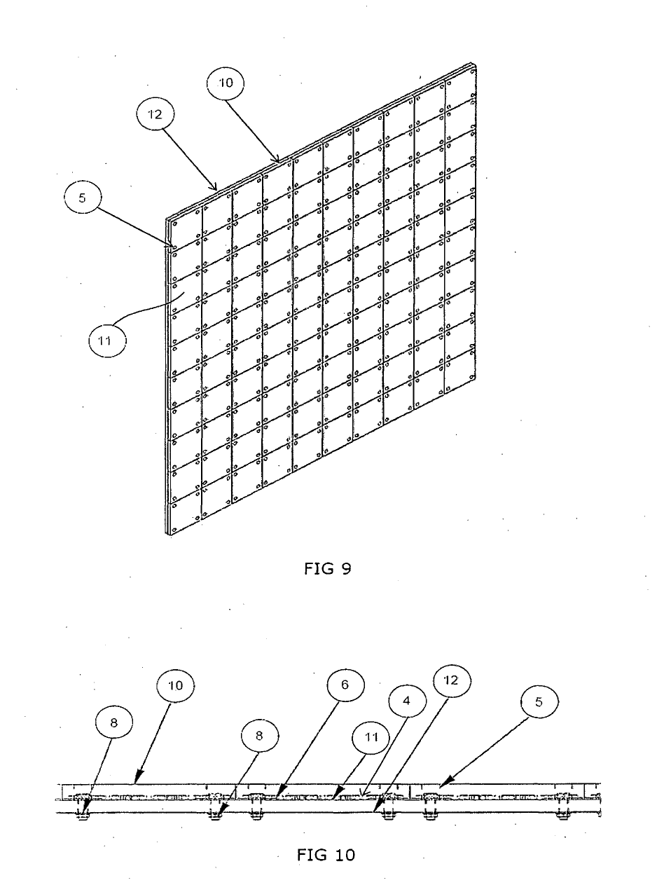

The liner has two surfaces. The front face (10) as shown in FIG. 2, takes the impact of the falling material and the back face (11) is located in close proximity of the chute wall (12) as shown in FIGS. 9 and 10. The said liner unit is adapted to be fixed on the chute wall (12) generally along the border of the frame (2) by suitable fastening means (8). The frame may be formed integrally with the liner base.

The frame (2) is seated on the back surface of the liner base in such a manner that the surface plane of the back face is always lower than the plane of the top surface of the frame. This ensures that the back face of the liner does not come in direct contact with the chute wall (12) once the liner unit is affixed thereon. Fixing of the frame to the chute wall provides a hollow space between the back face of the liner and the chute surface which holds trapped air, providing dampening effect through air cushioning during operation.

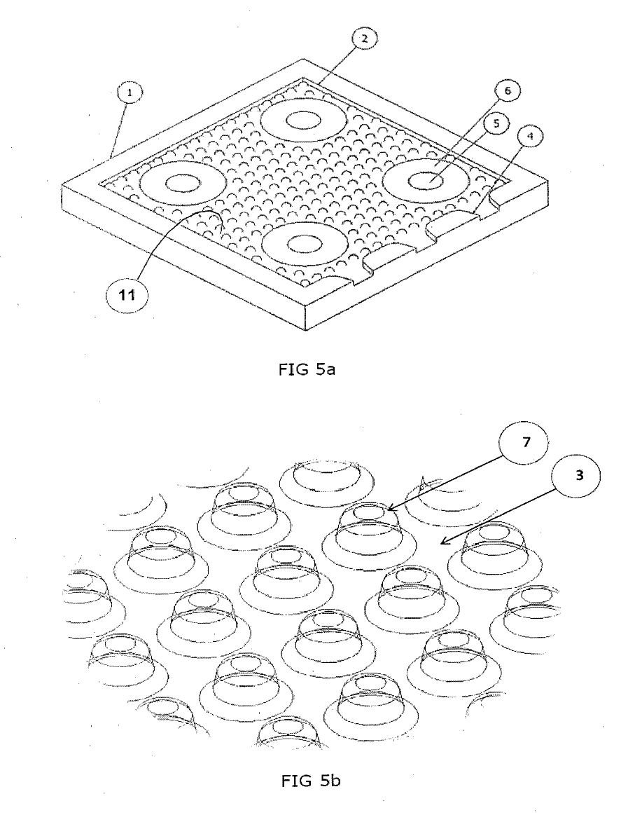

The frame (2) is provided with bolt holes (5) generally at the corners of, the rectangular frame (2). However, such bolt holes may also be provided on the liner base surface as shown in FIG. 5a. The bolt holes are preferably provided on cylindrical portions (6) having washers at its base for proper seating and firm gripping of the liner on the chute wall (12) so that the fasteners fixed therein are not loosened due to vibrations during operation of the chute. This also prevents unwanted material from entering into the hollow space between the liner back surface and the chute wall. It will be clear to a person skilled in the art that the shape and position of the bolt holes and the washers may widely vary and such shapes and positioning fall within the ambit of this disclosure.

The back face (11) of the liner is provided with plurality of pockets (3) of predetermined shapes and sizes all along the said surface.

The back face (11) of the liner is preferably also provided with plurality of integrally formed spaced apart longitudinal protrusions extending outwardly from the said back surface. These protrusions are generally termed as bubbles (7) in the specification for the sake of brevity. The shape and size of these bubbles may widely vary, as would be clear from the description later.

The frame (2) may further be provided with a plurality of slots (4) at one or more of its sides. These slots allow any material getting stuck within the pockets (3) to come out easily, thereby preventing jamming or clogging of the pockets.

As shown in FIG. 1, the formation of plurality of bubbles results in formation of adjacent pockets (3) with various shapes. The pockets basically occupy the space created on the liner base surface by the formation of the bubbles and provide space for air which is pivotal for air cushioning of the liner unit.

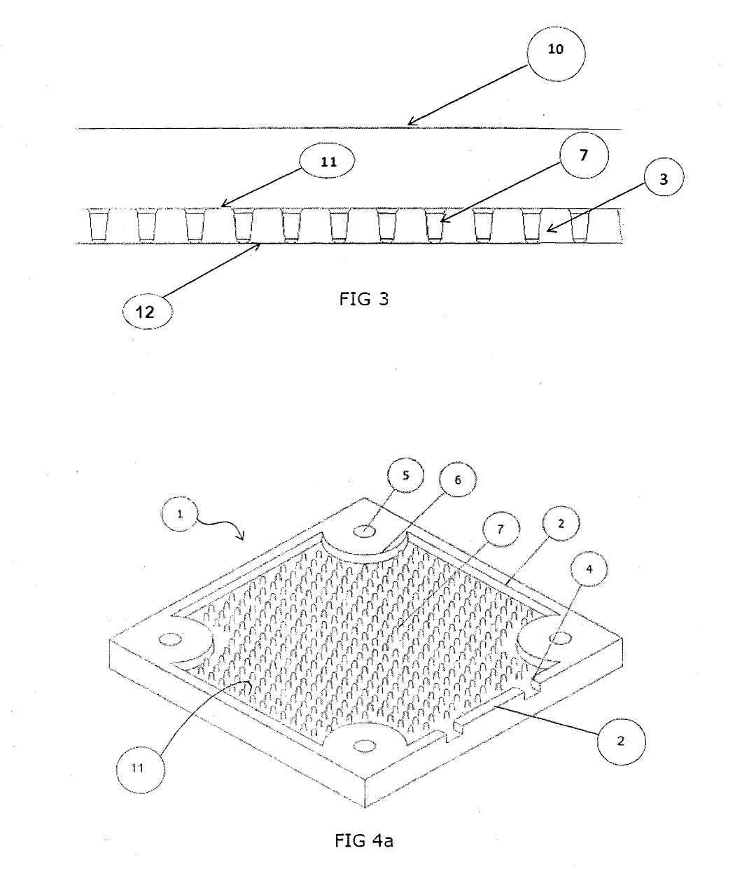

FIG. 3 shows an embodiment of the liner unit affixed on the chute wall (12) wherein a plurality of bubbles (7) and pockets (3) are provided on the back surface of the liner. The bubbles being longitudinally extended in an outwardly direction, they come in contact with the chute wall while the front surface (10) of the liner base is deformed downwardly due to impact load of material on it. The bubbles being made of the same non-linear material, these in conjunction with the associated pockets formed in the spaces between the bubbles provide a cushioning effect on the chute surface, thereby reducing impact load and wear and tear on the chute wall (12) surface.

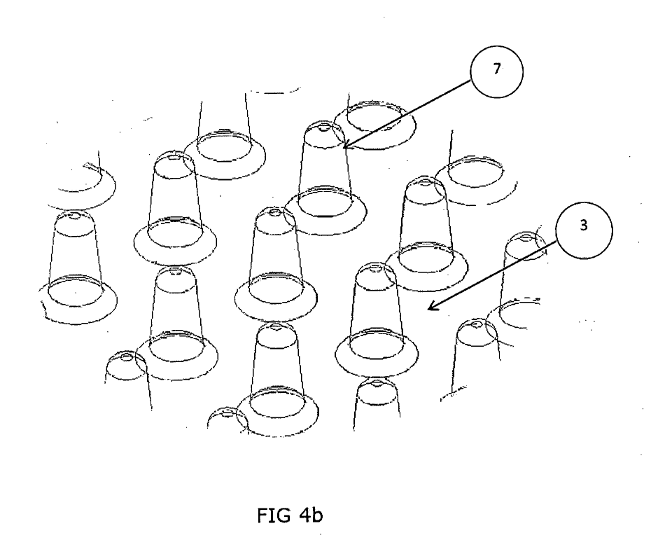

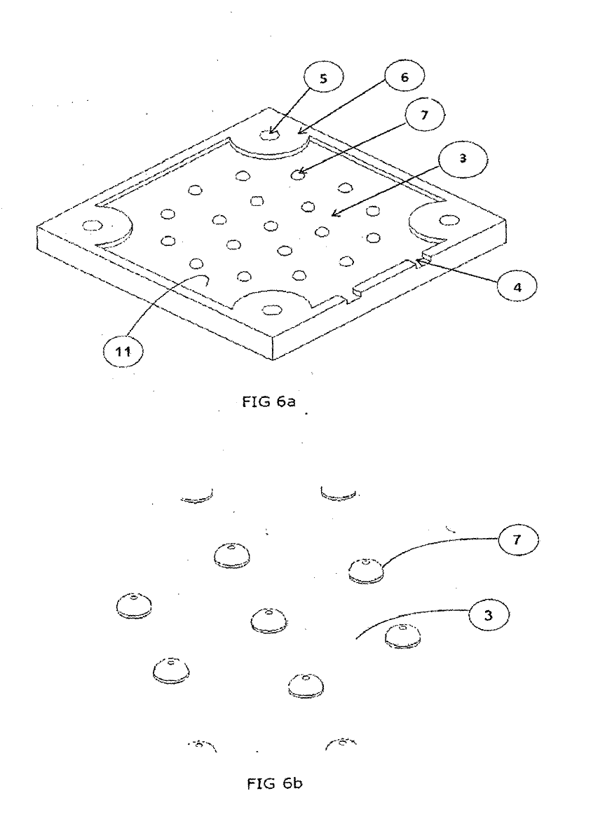

Some possible and non-limiting shapes of the bubbles (7) are shown in FIGS. 4a and 4b, 5b and 6a. Bubbles (7) may be thin, long and densely arranged brush-like protrusions. In other embodiments, bubbles (7) may be shorter, conical, button-shaped and located in moderately dense arrangements. The bubbles (7) may also be hemispherical and such bubbles are located in fairy spaced-apart arrangements. The impact force on the chute wall is primarily reduced in the liner due to bending or compression of the bubbles along their length and bending of the plane of the liner body in a direction perpendicular to the plane of the liner face (11).

This bubble-and-pocket arrangement may be provided on the front face (10) of the liner base also.

As shown in FIGS. 3, 4b, 5b and 6b, the pockets (3) may be of various shapes and sizes. However, the shapes, number and positions of the pockets are not limited to only these. These pockets form air cushions and provide damping action to the liners, enabling the liners and consequently the chute wall to withstand high impact forces.

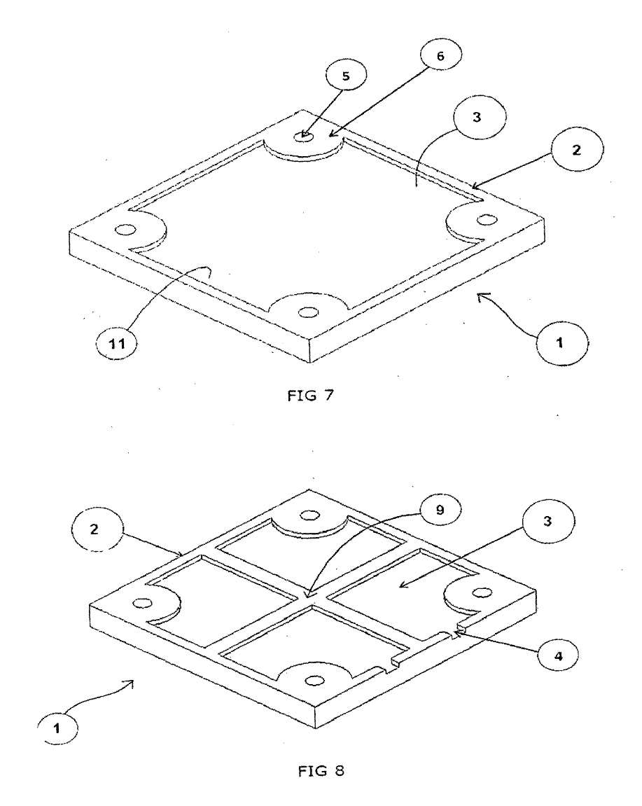

In another preferred embodiment shown in FIG. 7, the liner base comprises only of a singular pocket (3) enclosed within the frame (2). In this embodiment the liner base may be devoid of any bubble at all.

The damping action is solely provided by the pocket formed between the back surface of the liner base and the chute wall. It is to be noted that as the frame (2) has a predetermined thickness, the back surface of the liner base does not come into contact with the chute wall even when the liner base is bent backwards due to high impact loads on its front surface during operation.

In a further preferred embodiment as shown in FIG. 8, the frame may have an integrally formed cross beam (9) to withstand high impact load on the liner base during operation. The height of the cross beam (9) is same as that of the frame (2).

FIG. 9 shows an isometric view of an array of a plurality of liner units which is to be detachably attached to the chute wall. A cross sectional view of arrangement of FIG. 9 is shown in FIG. 10. As can be seen from FIG. 10, a plurality of bolts (8) acting as the fastening means are used to fix a plurality of liner units on to the chute wall (12) and that there is a clear gap between the back surface (11) and the chute wall (12).

The advantages of the present invention are:
1. Reduced impact wear
2. Reduced noise
3. Possibility of installation in high impact zones
4. Reduced material weight
5. Reduced cost
6. Elimination of frequent chute replacement
7. Reduction in stoppage of operation

The present invention has been described with the help of a preferred embodiment and it will be understood that various modifications of the present invention is possible without departing from the scope of the invention as described in the preceding description and the appended claims.

1. A liner unit adapted to be detachably attached on a chute wall comprises a liner base enclosed within an integrally formed frame and having a front and a back face, said liner unit is adapted to be affixed with the said chute wall through bolt holes by means of fastening means, said liner base being provided with pockets on the surface thereof providing cushioning effect in the event of the liner base being impacted with a load during operation.

2. The liner unit as claimed in claim 1, wherein the surface of said liner base is provided with plurality of spaced apart, integrally formed and longitudinally outwardly protruding protrusions.

3. The liner unit as claimed in claim 2, wherein the surface of the liner is provided with a plurality of spaced apart pockets.

4. The liner unit as claimed in claims 3, wherein the plurality of protrusions and pockets are of different shapes and sizes.

5. The liner unit as claimed in claim 4, wherein formation of the protrusions on the liner surface causes creation of the pockets.

6. The liner unit as claimed in claim 1, wherein it is provided with a plurality of bolt holes for fastening purposes.

7. The liner unit as claimed in claim 6, wherein said bolt holes are provided at the corners of the frame.

8. The liner unit as claimed in claim 6, wherein said bolt holes are provided on integrally formed cylindrical portions surrounding the bolt holes.

9. The liner unit as claimed in claim 1, wherein a plurality of slots is provided on said frame.

10. The bubble liner unit as claimed in claim 6, wherein said bolt holes on said cylindrical portions are located of the surface of the said liner base.

11. The bubble liner unit as claimed in claim 6, wherein said frame has an integrally formed cross beam.

12. An array of liner units adapted to be affixed on chute wall, formed by coplanar connection of a plurality of said liner units as claimed in claim 1.
